(19) United States
(12) Patent Application Publication
(10) Pub. No.: US 2013/0300551 A1
(43) Pub. Date: Nov. 14, 2013

(54) OBJECT PROXIMITY SYSTEM

(71) Applicants: Steven J. Weber, Germantown, WI (US); Ravi Kumar Koppula, Cupertino, CA (US); Ashok Teckchandani, Fremont, CA (US); Kailasnath Dornadula, Fremont, CA (US); Albert Calpito, JR., San Jose, CA (US); Ram Charan, E. Palo Alto, CA (US); Joseph L. Eldridge, Libertyville, IL (US)

(72) Inventors: Steven J. Weber, Germantown, WI (US); Ravi Kumar Koppula, Cupertino, CA (US); Ashok Teckchandani, Fremont, CA (US); Kailasnath Dornadula, Fremont, CA (US); Albert Calpito, JR., San Jose, CA (US); Ram Charan, E. Palo Alto, CA (US); Joseph L. Eldridge, Libertyville, IL (US)

(21) Appl. No.: 13/468,447

(22) Filed: May 10, 2012

(51) Int. Cl. B60Q 1/00

(52) U.S. Cl. 340/435

(57) ABSTRACT

An object proximity alert system for an object network includes an object module having a data processing unit; a GPS unit; and a transceiver, the latter both connected to the data processing unit. A first object in the network has the module, such that the data processing unit obtains first object position data from the GPS unit, calculates the speed of the object, and transmits position data using the transceiver to other network objects, the data processing unit calculates the respective positions of the first object with the objects in the network based on the data, and compares the position data against a preset target separation between the first object and the other objects. In the event a separation distance between the first object and another object in the network is less than the target separation, the data processing unit generates an alarm in at least the first object.

### BACKGROUND

The present invention relates to systems for monitoring the position of objects relative to other objects, and more specifically to such systems that provide a warning to vehicle operators of the upcoming proximity of vehicles relative to each other.

Vehicle proximity alert systems are known for automobiles and trucks traveling on conventional roads, where each vehicle transmits a signal that is received by other vehicles. As the vehicles move closer to each other, the nature of the signal changes, alerting the operator that a vehicle is approaching, such that the operator can adjust the speed or direction of travel of his vehicle. In some cases, the systems automatically adjust the speed or direction of the vehicle as needed.

In the case of vehicles traveling on railroads, such as trains and railway maintenance vehicles, the operator or engineer relies ultimately on his vision in gauging the relative position of nearby vehicles on the track. However, in some cases, such as inclement weather, or geographic obstacles such as mountains, hills, depressions, curves in the railroad, or the like, it may be difficult to see another vehicle on the same track that is in close proximity to the operator's vehicle. Once another vehicle is seen on the track, the operator can adjust his speed, but not his direction. In many cases, there are long distances to the next crossing, track intersection, siding or switch area, so rapid change of direction is usually not an option. Also, due to the relatively heavy rolling mass of trains and railroad maintenance machinery, and the potentially relatively low coefficient of friction between steel rail wheels and steel track, it is difficult to stop a rail vehicle in a relatively short distance. Thus, rail vehicles have relatively longer stopping or braking distances than vehicles with rubber tires travelling on conventional roads.

Conventional vehicle proximity systems have been unsuitable for use with railroad vehicles due to the problems created by geographical obstacles, turns, dips or curves in the track and the longer stopping distances. For example, ultrasonic transmitters are unsuitable for use around curves in the track, and often generate false alarms caused by objects located along the track such as removed ties and other types of railway components. Doppler radar transmitters require visibility between the respective vehicles and as such are less effective when hills, mountains or other obstacles are present. Also, objects located along the track generate false alarms, which frustrate the operators, who then often disable the systems. Another drawback of Doppler transmitters is that they operate by calculating changes in distance between vehicles, rather than the exact distance. Conventional radar does not operate effectively around geographic obstacles, is impaired in bright sunlight, and is less accurate as distances increase between vehicles. Thus, there is a need for a more reliable warning system for alerting operators of rail vehicles as to the proximity of other objects, personnel and/or vehicles within a specified distance of a target or subject object, such as a vehicle.

### SUMMARY

Accordingly, the above-listed needs are met or exceeded by the present object proximity system which provides an alert to the operator of a moving object, such as a vehicle that the vehicle is approaching another fixed or moving object, including but not limited to a stationary or moving vehicle, fixed object or individuals such as railway maintenance workers or the like, and that at least one of speed and direction should be adjusted in the present object. An advantage of the present system is that it has a range exceeding that of the vision of the operator, and can better cope with geographic obstacles such as mountains, hills, depressions, curves in the direction of travel, or inclement weather, etc. In addition, the present system is designed primarily for alerting the operator to the proximity of another object, and as such is relatively simple with few components and reduced maintenance costs. The present system also is designed to provide the operator sufficient warning time for permitting corrective action, given the relatively longer required stopping distances of railroad vehicles.

Another feature of the present system is that the intensity, as in frequency or volume of the alarm increases as the distance decreases between the respective objects. A related feature is that the data processor is configured such that the target distance changes with the speed of the present object, sometimes referred to in this application as the subject vehicle, wherein target distance shortens as vehicle speed decreases. Also, the present system sends warning signals to at least the present object and the next adjacent object in the system, as well as optionally to other objects within a prescribed geographic area. Still another feature is that the present system detects other objects connected to the system relative to both forward and rear ends of the present machine. In applications where monitored machines or vehicles are intentionally in close proximity to each other, the present system features a temporary manual override of the alarm triggers.

In the present system, each object has three main components: a global positioning system (GPS), a radio transceiver and a central data processing unit (DPU). Each object continually transmits at least its position. Further, the transceiver receives the position data transmitted by other objects connected to the present system. The DPU in each vehicle or other object receives the respective position data of the present object and the other objects connected to the system, and determines whether the present machine is within a prescribed target distance of another machine in the system. If two machines are within the prescribed distance, an alarm is generated.

More specifically, the present object proximity alert system is provided for use with an object network, and includes an object module having a GPS unit and a transceiver both connected to a data processing unit. A first object in the network has the object module, such that the data processing unit obtains first object position data from the GPS unit, calculates object speed and transmits the position data using the transceiver to other network vehicles. The data processing unit calculates the respective positions of the first object with other objects in the network based on the data, and compares the position data against a preset target separation between the first object and the other objects. In the event a separation distance between the first object and another object in the network is less than the target separation, the data processing unit generates an alarm in at least the first object.

### BRIEF DESCRIPTION OF THE DRAWINGS

FIG. 1 is a schematic of the components of the present system mounted in each vehicle or other object;

FIG. 2 is an schematic overhead plan view of multiple objects on a railroad track and connected to the present system; and

FIG. 3 is a schematic representing the position-related calculations performed by the onboard computer of the present system.

### DETAILED DESCRIPTION

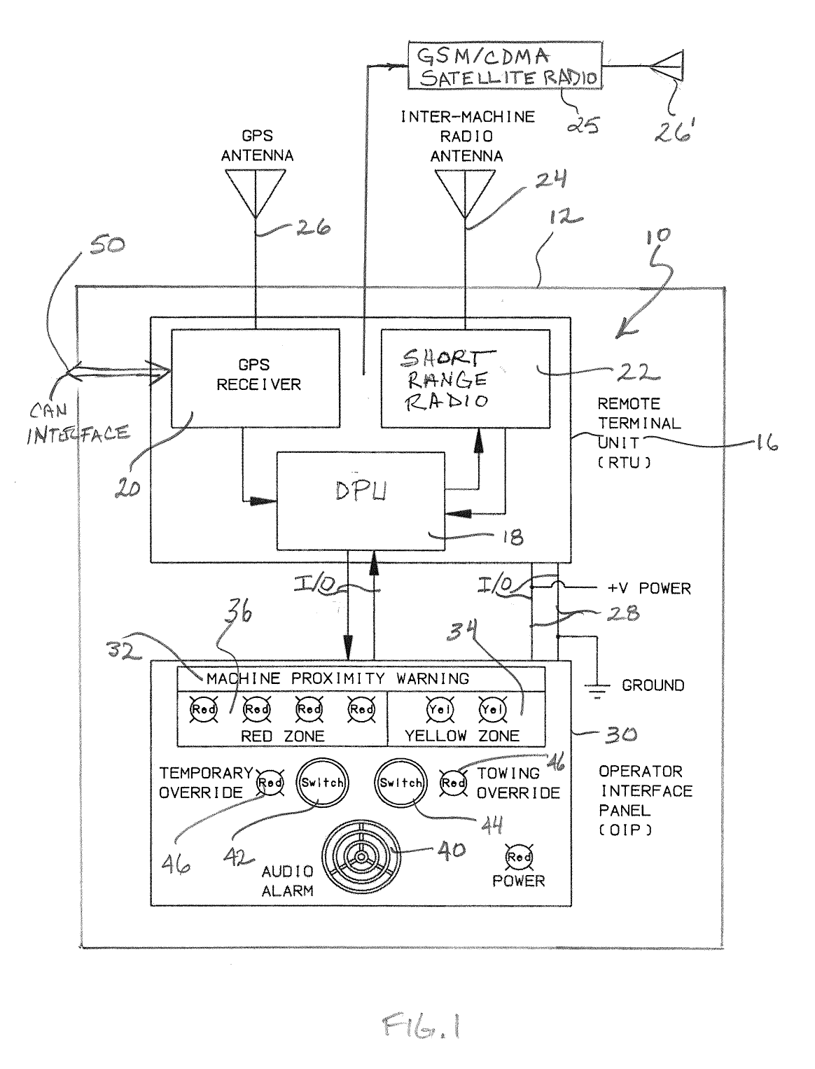

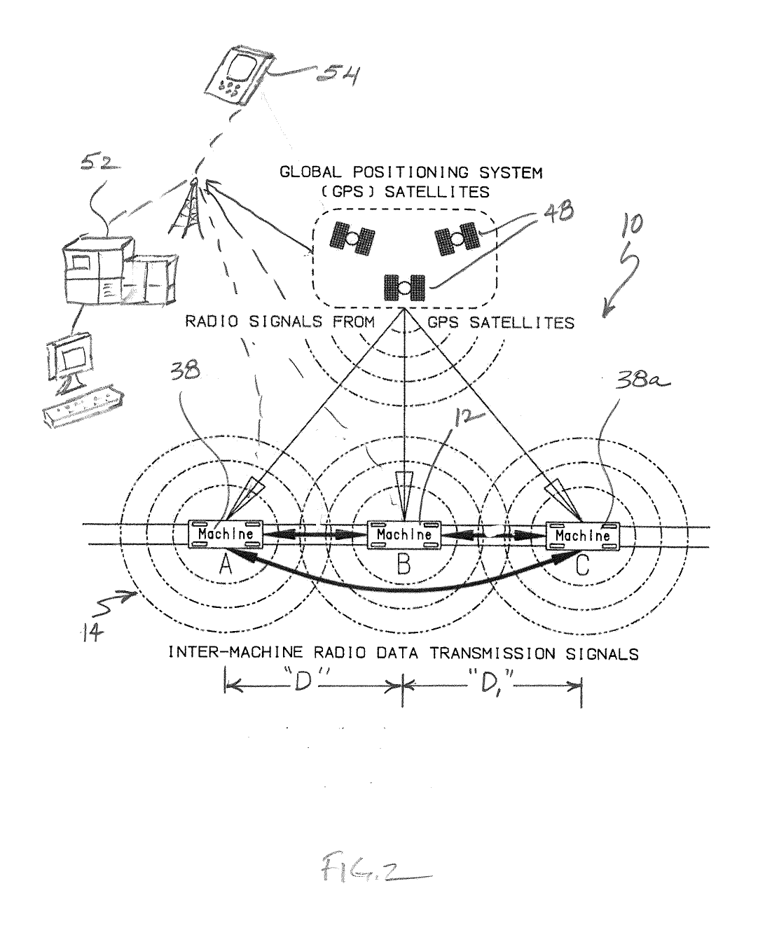

Referring now to FIGS. 1 and 2, the present object proximity system is generally designated 10, and will first be described in relation to a first object or subject vehicle, schematically referred to at 12. In the preferred embodiment, the objects are vehicles, such as those operating on railroad track. However, other monitored objects are contemplated as being included in the present system 10, including but not limited to machinery mounted on fixed or movable platforms, fixed natural or man-made structures, as well as personnel such as railway maintenance workers or the like. In the context of the present application, the terms “object” and “vehicle” should be considered to be broadly defined equivalents, with a “vehicle” being one type of “object.” The first object 12 is preferably contemplated as being any type of self-powered vehicle designed for travel on road or railroad track; however in an especially preferred embodiment the object 12 is a railroad vehicle such as a locomotive or a self-propelled rail maintenance vehicle.

While the following description is provided in relation to the first object or subject vehicle 12, it will be understood that the system 10 contemplates several such monitored objects or vehicles, each equipped with similar equipment as described below. One of the purposes of the present system 10 is to determine the relative proximity of objects or vehicles connected to the system. A main objective of the present system 10 is to provide machine operators information about other network-connected objects or vehicles which are in close proximity to their particular object or subject vehicle. If the subject vehicle is within a specified target distance of another vehicle in the network, an alarm is triggered by an onboard data processing unit. The purpose of the alarm is to alert the operator to adjust the speed of his vehicle for preventing the subject vehicle and a next adjacent vehicle from achieving the same position.

The vehicle 12, as well as other similar vehicles in a network 14 of such vehicles, is provided with an object module 16, also referred to as a remote terminal unit, including a data processing unit 18 such as a computer or the like, a GPS unit 20 electrically connected to the data processing unit and a transceiver or Short Range Radio module 22 connected to the data processing unit. The transceiver 22 is at least one of a radio transceiver, a cellular transceiver and a satellite transceiver, and has a respective antenna 24. In the preferred embodiment, the transceiver 22 is a radio transceiver. In addition to the GPS 20 and Short Range Radio module 22 in the system, a GSM/CDMA/Satellite Radio module 25 is optionally included. The module 25 allows connectivity with a remote server (not shown) so that the data can be stored in a remote database and the system 10 can be controlled by the server. As is known in the art, the GPS unit 20 and the Satellite Radio module 25 also have a corresponding antenna 26, 26′. Power is supplied to the system 10 through the vehicle electric system, typically operating at 12 to 24 Volts as is known in the art.

The module 16 is electrically connected, by inputs/outputs 28 such as wires or wirelessly, as is known in the art, to an operator interface panel 30 located in the vehicle 12, as in an operator cab or workstation, as is well known in the art. Shown schematically, the operator interface panel 30 is contemplated as taking a variety of forms of controls and displays, and in the preferred embodiment includes a proximity warning display 32, having at least one first visual warning display 34 and at least one second visual warning display 36. In the preferred embodiment, the first and second visual displays 34, 36 are different colors, for example yellow and red, to indicate the progressive proximity of the first object 12 to a closest second object 38, also preferably but not exclusively a vehicle, in the network 14. Thus, as a separation distance “D” (FIG. 2) between the subject vehicle 12 and the second object 38 shrinks below a predetermined target distance, the visual displays 34, 36 are progressively illuminated by the operator interface panel 30 under the control of the data processing unit 18.

In addition to the visual alarm displays 34, 36, the operator interface panel 30 is provided with an audio alarm 40. As an option, the object module 16 is provided with a tactile alarm (not shown), which alerts the operator by vibration transmitted through various vehicle controls, such as joysticks or the like.

As will be described in further detail below, the operator interface panel 30 is provided with at least one, and preferably a pair of override controls, including a temporary override 42 control and a towing override 44 control, each having a visual indicator 46 to display when the override is activated.

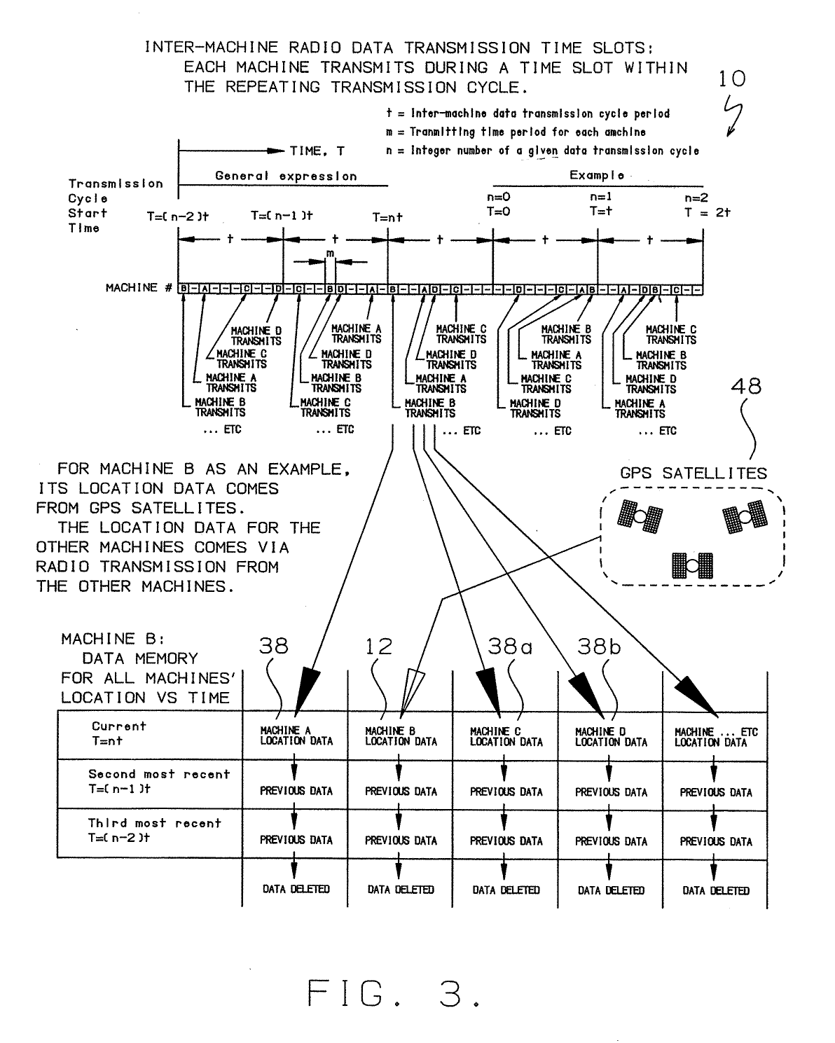

As seen in FIGS. 1 and 2, in the system 10, which will be described in relation to the first object 12, the GPS unit 20, communicates with satellites 48 to obtain position data of the first object in the network 14 based on X and Y coordinates as observed by the satellite, and transmit the position data to the data processing unit 18 so that the position and speed of the first object is calculated, and then transmits the position data using the transceiver 22 to the next adjacent object/vehicle 38 and to other objects/vehicles 38a, 38b (FIG. 3), etc. The transceiver 22 receives X and Y position data from the other objects as well. Next, the data processing unit 18 compares the calculated position data against a preset target separation between the first object 12 and the closest object 38, as well as relative to other objects in the network. In the event the separation distance “D,” between the first object 12 and the closest object 38 in the network 14 is less than the target separation, the data processing unit 18 generates an alarm 34, 36, 40 on the operator interface panel 30 in at least the first object. In the preferred embodiment, alarms are triggered in both the first object 12 and the closest object 38 so that both operators are notified of the relative proximity of the objects in sufficient time to take action, such as reducing speed.

The data processing unit (DPU) 18 is preferably configured so that the visual alarm displays 34, 36 are triggered upon preselected distances between the first object 12 and the closest object 38. These distances are monitored by interaction between the GPS unit 20 and the data processing unit 18. For example, the first visual warning display 34, preferably displaying yellow or another relatively low alarm level color, is triggered when the distance D is less than a preselected distance, but providing the operator or user with plenty of time to reduce speed. For example, while the object 12 is in a traveling mode, traveling upon the track at speeds greater than 10 mph, the first visual warning 34 is triggered when D is 450 feet or less. Then, as D is reduced, as the objects 12 and 38 become closer together, the second visual warning display 36, typically red or another color designating a higher alarm level, is triggered by the data processing unit 18. For example, the display 36 is triggered when D is 300 feet or less, providing the operator sufficient time to take effective action so that the objects 12 and 38 do not occupy the same position. It is contemplated that the specific trigger points and speeds may vary to suit the application.

It is also contemplated that the system 10 is designed such that the above-described target distances preferably vary as a function of the speed of the object 12. Thus, in addition to the above-identified alarm trigger points, the data processing unit 18 is programmed with a second set of alarm trigger points intended for use when the object 12, such as a railway maintenance machine, is in a working mode on the track, and traveling at a relatively slow speed, such as 5 mph or less. In such situations, the objects 12, 38 need less distance to stop before the situation occurs where their positions coincide. During the working mode, the first visual alarm display 34 is preferably triggered when D is 150 feet or less, and the second visual alarm display 36 is triggered when D is 75 feet or less. In other words, the color of the alarm varies as the distance D decreases between the objects 12, 38, and the data processing unit is configured for changing the alarm trigger points based on the speed of the first object 12.

In addition, there is still another alarm trigger point algorithm based on the projected time separation between objects 12 that are becoming closer together and measures a time at which both objects will occupy the same space. In a preferred embodiment, a “yellow zone” begins at 30 seconds prior to such occupation, and a “red zone” begins at 15 seconds prior to such separation. Thus, the data processing unit 18 is configured for changing an alarm trigger point based on the projected time separation between the first object/subject vehicle 12 and another vehicle 38 whose separation distance is decreasing.

Referring now to FIGS. 2 and 3, the present system 10 is also configured such that the GPS unit 20 obtains position data of the first object 12. The position data is repeatedly monitored over time and transmitted to the data processing unit 18, which thus calculates the speed of the object 12. Object direction is thus not specifically calculated, but is implied from the position and speed data. The positions of the first object 12, the adjacent object 38 and similar objects in the network 14, measured from the separation of the respective antennae 26, are transmitted from each respective data processing unit 18 to the units in each object by the transceiver 22 located in each object. As seen in FIG. 3, each object is assigned a specific time slot in a periodic transmission cycle having a designated data transmission frequency, such as t=once every second, up to every two or three seconds. Alternatively, the time slot is selected randomly. This interval may vary to suit the application. The transmission cycle for each object is based on a formula: T=(n−2)t; T=(n−1)t; T=nt; etc., where T=time; n=an integer number of a given data transmission cycle; and m=transmitting time period for each object, and t=inter-object data transmission cycle period.

For a given object or vehicle 12, the current data transmission is calculated by T=nt, and speed (speed is available in the data packet from the preferred GPS. A rate of change in distance between two objects is calculated by data received in multiple transmissions.) is calculated by comparing with the next previous data transmission, calculated as T=(n−1)t, to determine the speed of the object. Once the speed of the object 12 is determined by the data processing unit 18, this data is compared with the received position data from the other objects 38, etc. and the alarm trigger point is set. In other words, the data processing unit 18 determines an appropriate target distance for the first object 12 based on speed, and the position of the next adjacent object 38 in the network 14, including a projected point where positions of the first object and the next adjacent object coincide. As seen in FIG. 3, the position/speed data is retained for several monitoring points, and then is deleted from the system as the object 12 travels upon the track. However, the data processing unit 18 is preferably configured for retaining a history of movement by the first object 12.

Referring now to FIG. 1, as identified above, the system 10 includes an override function, including the temporary override 42 control, the towing override control 44 and the override activation display 46. In the preferred embodiment, the controls 42, 44 are user-activated pressable buttons; however other user-activated controls are contemplated. The temporary override control 42 is contemplated for use when respective objects 12, 38 are working in a gang or team as is well known in the railway maintenance art, and are in close proximity for crossing a highway or other equivalent situation that is short lived. The user activates the temporary override control 42, which turns off the alarm for a specified period of time, such as 15 minutes, which can vary with the application.

Alternately, the towing override control 44 is contemplated for use for longer periods of time, when one object 12, 38 tows another, and as such the objects are within the target distance of each other, which under normal circumstances would trigger an alarm. In the towing mode, the engine of one object will be turned off, and pressing the tow override control 44 will terminate communication between the first object 12 and the system 10. When operating in this mode, no other alarms are activated or displays shown. Once the user activates the designated control 42, 44 only the display 46 is illuminated. In the event the engine is turned on, the towing mode 44 is reset.

In addition, the data processing unit 18 is preferably configured so that the user can temporarily disable the transceiver 22, and an alarm is generated if the GPS unit 20 loses its signal. Another preferred feature of the system 10 is that each object 12, 38, has a distinct identification signal that is transmitted to each other object in the network 14. Still another feature of the system 10 is that it remains active even after the engine of the object 12, 38 is turned off.

Another feature of the system 10 is the capability for updating the control software or firmware remotely by wireless connection. In addition, the system 10 has a serial port for use in debugging. The system 10 also supports CAN bus interface 50 (See FIG. 1). Further, the system 10 is supported by a dedicated website. As shown in FIG. 2, all data from all the objects 12 is sent via internet to a data center 52. Users with authorized login and password can view information about all the objects on the website. An object 12 can be configured and controlled at the website. The user can view all the faults and alarms with a single click on the website. The system 10 is also preferably supported by a SmartPhone application. Data can be pushed to a Smart Phone 54 (FIG. 2) from the data center 52 via the Internet. An object 12 can be configured and controlled by the application on the Smart Phone 54. The user can also view the alarms and faults for the objects 12. Another feature of the system 10 is the use of additional memory (SD card/hard disk drive, etc.) where data and information for all the system activity is stored. This allows Black Box architecture to replay the stored data and help in analyzing the data for the purpose of training and monitoring.

While a particular embodiment of the present object proximity system has been described herein, it will be appreciated by those skilled in the art that changes and modifications may be made thereto without departing from the invention in its broader aspects and as set forth in the following claims.

1. An object proximity alert system for use with a plurality of objects forming a network, comprising:
an object module including:
a data processing unit;
a GPS unit connected to said data processing unit; and
a transceiver connected to said data processing unit;
a first object in said network having said object module, such that said data processing unit obtains position data of said first object from said GPS unit, calculates a speed of said first object and transmits said position data using said transceiver to other objects in said network, said data processing unit calculates the respective positions of said first object with the objects in said network based on said data, and compares said position data against a preset target separation between said first object and said other objects, and in the event a separation distance between said first object and another object in said network is less than said target separation, said data processing unit generates an alarm in at least said first object.

2. The system of claim 1 wherein said alarm is at least one of visual and audible and tactile.

3. The system of claim 2 wherein said alarm is visual and changes color as the distance decreases between said subject vehicle and the next adjacent vehicle in said system.

4. The system of claim 1 wherein said transceiver is at least one of a radio, a cellular transceiver and a satellite transceiver.

5. The system of claim 1 wherein said data processing unit is configured for changing an alarm trigger point based on the speed of said first object.

6. The system of claim 5 wherein said data processing unit is configured for calculating an X and a Y coordinate position of said object and comparing said position against a calculated X and Y position of a next closest object in said network.

7. The system of claim 6 wherein said data processing unit is configured for calculating said coordinate position at an initial time, and calculating said coordinate position at a specified time interval, and for determining the speed of said first object based on the change in said calculated positions over time, and for determining an appropriate target distance based on said speed.

8. The system of claim 1 wherein said data processing unit is configured for changing an alarm trigger point based on the projected time separation between said first object and another object whose separation distance is decreasing.

9. The system of claim 1 wherein said data processing unit is configured such that said target distance changes as a function of speed of said first object.

10. The system of claim 9 wherein said target distance is reduced as said speed of said first object decreases.

11. The system of claim 1 wherein said data processing unit is configured receiving data from said GPS unit for calculating a time when positions of said first object and another object in said network coincide.

12. The system of claim 1 further including said data processing unit being provided with an override of an alarm signal trigger generated by said unit when said first object is within a specified distance of another object in said system.

13. The system of claim 1 wherein said data processing unit is configured for temporarily disabling said transceiver under operator control.

14. The system of claim 1 wherein said data processing unit is configured for generating an alarm if said GPS unit loses its signal.

15. The system of claim 1 wherein each object in said system has a distinct identification signal that is transmitted to each other object in said network.

16. The system of claim 1 wherein said data processing unit retains a history of the movement of said first object.
